(19) United States
(12) Patent Application Publication
(10) Pub. No.: US 2012/0144747 A1
(43) Pub. Date: Jun. 14, 2012

(54) LIGHT-BLOCKING WINDOW SHUTTER

(76) Inventor: Ronald L. Swapp, Henderson, NV (US)

(21) Appl. No.: 13/238,304

(22) Filed: Sep. 21, 2011

Related U.S. Application Data
(60) Provisional application No. 61/403,837, filed on Sep. 21, 2010.
(60) Provisional application No. 61/572,424, filed on Jul. 15, 2011.

(51) Int. Cl. E06B 7/08; E06B 7/00

(52) U.S. Cl. 49/74.1; 49/507

(57) ABSTRACT

A window shutter assembly having flexible light blocking seals molded in the frame or on the edges of the stop surface of the frame. The invention also includes fasteners for securing the louver frame of shutters and also for applying tension to the louvers to resist undesired louver tilt due to wear and the effects of gravity. Additional light blocking features include T-shaped strips of a fibrous material which is secured to a suitable location such as in a groove along the side of the louver panel stile and louvers having edges which inter-engage in the closed position to efficiently block light.

### CROSS-REFERENCE TO RELATED APPLICATIONS

This application claims the benefit of U.S. Provisional Patent Application No. 61/403,837 filed Sep. 21, 2010 and U.S. Provisional Patent Application No. 61/572,424 filed Jul. 15, 2011 the contents of which are hereby incorporated by reference.

### TECHNICAL FIELD

This description relates generally to window shutters and more specifically relates to window shutters having features to improve the performance, durability and operation of the shutters and also to substantially reduce light infiltration between the shutter frame and louvers, and other openings often inherent in shutter construction.

### BACKGROUND

Various types of interior window treatments are utilized in both residential and commercial buildings. One such widely used and accepted window treatment is the shutter. Shutters are popular because of their pleasing aesthetic appearance, versatility, adjustability and other functional advantages.

One functional advantage of shutters is that the shutters can be provided with louvers which can be positioned or adjusted to change the desired light level and also to deflect light or reduce glare. Shutters are also insulative and assist in reducing the heat load transfer to the interior area through a window opening. Shutters are manufactured to fit window openings having a wide variety of sizes and shapes.

In the past, shutters have been made primarily of wood. Modern shutters are increasingly fabricated from more durable materials such as polymeric materials or a combination of composite materials such as wood and synthetic polymers. Common materials are polyvinyl chloride, polystyrene, polyurethane, polypropylene and composites of these materials. However wood shutters typically are quite rigid, and components such as louvers when made from polymeric materials alone may sag or bend, as they lack the rigidity of wood.

Fabrication of shutter components using various synthetic and engineered materials makes the manufacturing technique more efficient as many of the components can be extruded whereas in the past these components, when made of wood, required multiple operations such as milling, planing, shaping drilling and routing in the assembly process. Despite the materials used to construct shutters, the components used and their assembly have not changed a lot. In a shutter there are often many cracks, or openings where light may come through. Thus typical shutters may not completely block light and must often be used in conjunction with curtains or the like to completely block light from entering a room.

Accordingly, there exists a need for a shutter with improved light blocking features. Also a polymeric shutter louver with improved rigidity would be useful.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a window shutter assembly having an exterior frame with vertical sides and horizontal top and bottom members which supports at least one louver panel with vertical stiles and top and bottom horizontal rails. The louver panel is hinged to the exterior frame so that the louver panel may open or close. A light blocking material may be included to prevent light from infiltrating space which may be present between the louver panel and frame. The louver panel comprises a plurality of louvers are arranged in parallel fashion and joined at opposite ends to the edges of the vertical stiles. The spaces between the louvers and stiles may also incorporate a light blocking material. The position of the louvers is established by a control rod or tilt rod connected to the individual louvers. The exterior frame which extends around the louver panels has a generally L-shaped, cross-sectional configuration to receive the louver panel and has a stop surface against which the louvers abut in a closed position.

With the present invention, a light-blocking seal is provided at various locations within the shutter assembly to substantially block light infiltration. In one embodiment, the light-blocking seal is in the form of a flexible member such as a flap integrally extruded as part of the shutter component, such as part of the exterior frame, or on the edge of the shutter panel stile to block light when the shutter panel is closed. The light-blocking seal is a flexible polymeric flap co-extruded with the stop surface of the exterior frame which seals areas between the shutter components which may otherwise allow light infiltration. The seal may also take other shapes such as round, oval or even semi-spherical.

The present invention can also eliminates the need for the structural divider rail that is common in larger louver panels such as those over 5 feet in height. Normally shutter panels of this size and larger have a fixed horizontal structural divider extending between the vertical stiles for structural integrity. A tight louver screw replaces dividers for taller shutter panels. The louver screw assembly includes a screw which extends from a recess in the vertical stile in which the head of the screw is located. The threaded portion of the screw extends through a bore into the adjacent louver panel. A thrust washer is interposed between the head of the screw and the bottom of the recess. Low friction washers of nylon or other material are preferably positioned on opposite sides of the thrust washer. The thrust washer supports rotation of the screws and the attached louver as a unit to provide structural integrity to the assembly maintaining the spacing between the vertical stiles, minimizing the tendency of the screw to “strip” from the louver ends.

In yet another embodiment of the present invention, a plurality of tension-control pins may be placed at selected locations between the stiles and the louvers, typically in about one-third of the locations. The tension-control pins secure the louvers and reduce wear by preventing the weight of the tilt rod from causing the louvers to pivot, particularly after wear has occurred.

Light-blocking around the various spaces described above may be accomplished is in the form of a strip of fibrous or pile, brush-like material having a generally round, T cross-sectional or other equivalent shape. The base of the T-shaped, flexible fibrous light-blocking strip is secured in suitable locations where light might infiltrate, such as in grooves routed in the edges of the vertical stiles and horizontal rails, as well as in the horizontal and vertical frame components.

Another light-blocking feature is the provision of interlocking or inter-engaging sections on the edges of the louvers. When the louvers are fully closed, these sections abut similar sections either on adjacent louvers or on an edge of a rail in interlocking or inter-engaging fashion to block light.

The present invention also provides an enhanced construction in which the individual louvers are a synthetic or composite material and are reinforced to further resist warpage and deformation due to wear, tear and environmental conditions.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a partial perspective view of a representative shutter assembly according to the present invention showing the exterior frame and an interior louver panel hinged to the exterior frame.

FIG. 2 shows light blocking material disposed between the frame and shutter panel.

FIG. 3 shows how light may be blocked from entering gaps between the shutter frame and wall.

FIG. 4 shows how light may be blocked from entering gaps that may be present between louvers and an aperture in the shutter panel in which the louvers are disposed.

FIG. 5 is a perspective view of a section of the exterior frame showing a co-extruded, light-blocking seal.

FIG. 6 is a cross-sectional view of a section of an exterior shutter frame as seen in FIG. 2 provided with another embodiment of the co-extruded light-blocking seal.

FIG. 7 is an enlarged detail view of a louver stile and attached louver broken away to show the installation of a tight louver screw to provide structural integrity in larger shutter assemblies not having a divider panel.

FIG. 8 is a detail view of a shutter stile and an adjacent louver broken away showing the installation of a tension-control pins placed between the stile and louver at selected locations to frictionally secure the louvers to prevent the tilt rod from causing the louvers to pivot.

FIG. 9 is a partial perspective view representative of a shutter frame section including a light seal, and an alternative example of alight seal for engaging the rails or stiles of the louver panel.

FIG. 10 is a cross-sectional view of an extruded louver having an embedded reinforcing member within the louver construction.

FIG. 11 is a perspective view of a louver having edges provided with grooves which inter-engage with adjacent louvers or shutter rails when the louvers are closed to block light.

FIG. 12 is a cross-sectional view showing two louvers each fabricated, as seen in FIG. 11, closed in a light-blocking position.

FIG. 13 shows an alternate embodiment of the light-blocking louver of FIG. 11.

FIG. 14 shows a further alternative example of louver construction that may increase louver rigidity, while saving materials.

FIG. 15 shows yet further alternative examples of lover construction.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

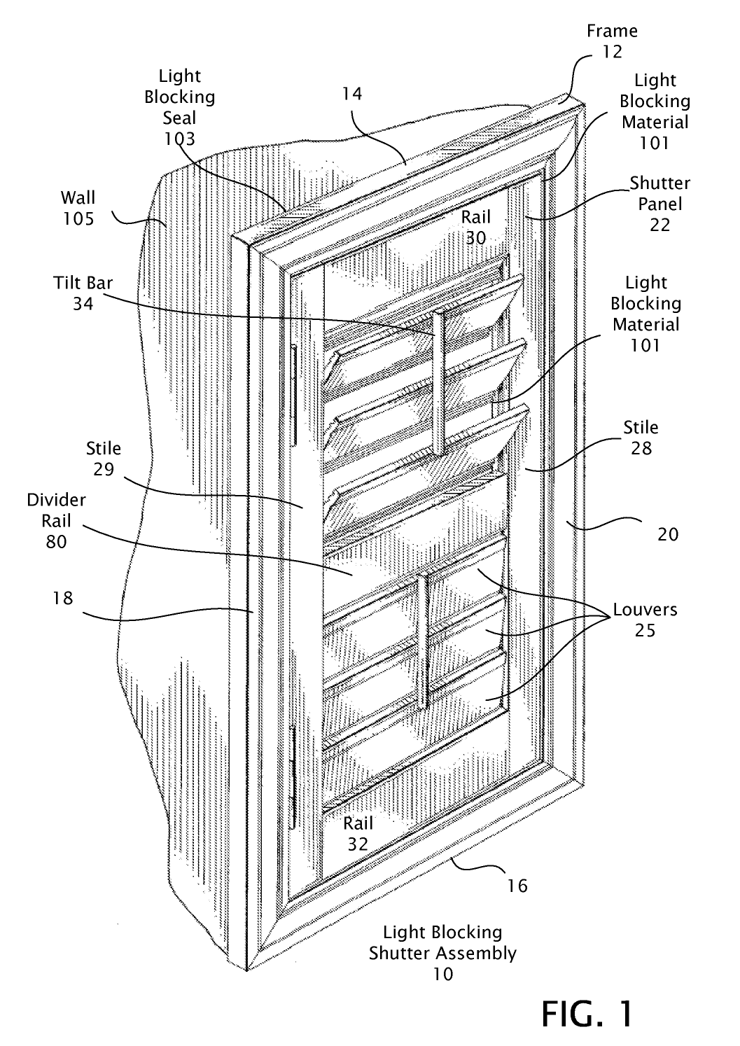

FIG. 1 shows a representative shutter assembly which is shown and is generally designated by the numeral 10. A problem common to both shutters fabricated from polymeric materials, as well as older, wood style shutters, is light infiltration between the pivotal louver frame and the fixed frame in which the louver frame is mounted. Light infiltration generally occurs between the stiles and the louvers and between the louvers as well as around the shutter frame where it meets the wall and between the shutter frame and the shutter panel.

The shutter assembly 10 has an exterior frame 12 which is shown as rectangular having an upper, lower and opposite sides 14, 16, 18 and 20 which extend around shutter panel 22. Shutter panel 22 is hinged to the frame 12 having multiple louvers 25 pivotally mounted at opposite ends to the stiles 28, 29. Rails 30, 32 extend between the stiles 28, 29 at the top and bottom of the shutter panel 22. A control rod or tilt bar 34 is provided to manually pivot the louvers 25 to establish a selected position to admit or block light. Although a single louver panel 22 is shown, the frame 12 may enclose two or more panels which are hinged either to the exterior frame 12 or to an adjacent louver panel. A divider rail 80 may be added for astetics, or to improve structural rigidity, especially in tall panels.

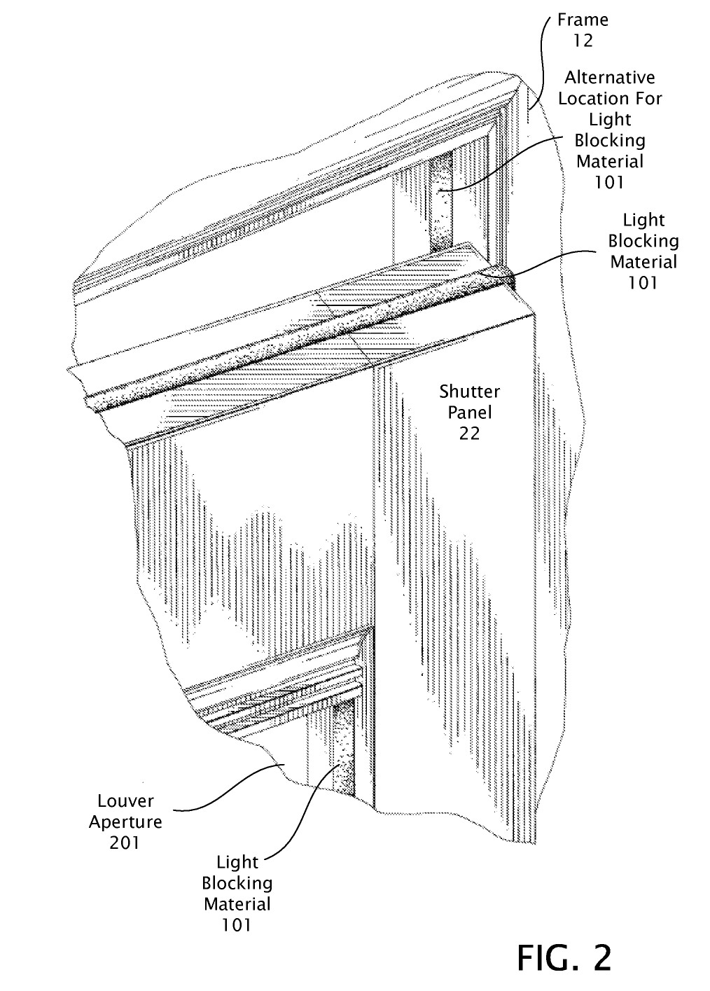

FIG. 2 shows light blocking material disposed between the frame and shutter panel. Light may leak around any gap that might be present between the frame and shutter panel. The shutter panel is typically hinged to the frame and there is typically a gap around the interface that can allow unwanted light to seep through. A light blocking material may be disposed into a side wall of the shutter panel, a side wall of the frame, or both in order to block light from seeping through. The light blocking material typically has enough give or pliability to effectively fill into any gaps between the frame and shutter panel when the shutter panel is closed into the frame. The filling of the gaps prevents unwanted light from passing into the room.

The shutter panel typically includes one or more louver apertures into which a plurality of louvers may be disposed. Where the ends of the louvers (not shown) abut a side wall of the shutter panel, light blocking material may be disposed there to fill gaps that would also allow unwanted light from entering the room.

The horizontal edges of the louvers may also form a pathway to admit unwanted light where the louvers at the end, and beginning of a set contact the shutter panel. In this case the top and/or bottom rail of the shutter panel and also the stile of the shutter panel may include a plurality of parallel groves that accept a plurality of mating groves disposed in the corresponding louver, where it would contact the shutter panel.

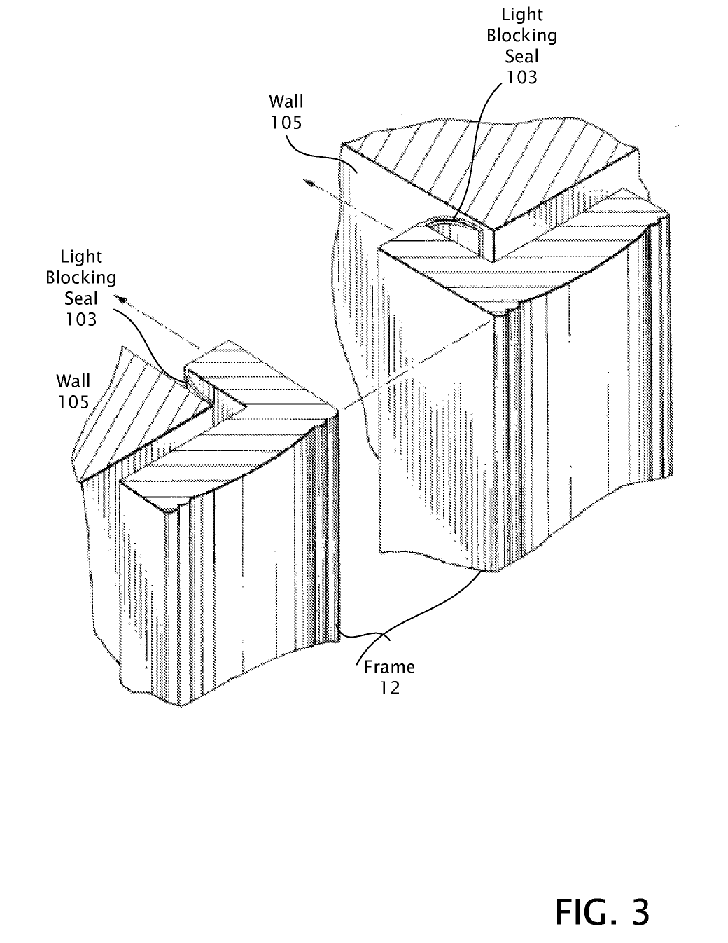

FIG. 3 shows how light may be blocked from entering gaps between the shutter frame 12 and wall 105. Rather than try to make a frame 12 an exact match to an opening, or to provide a separate gasket to seal out light, a light blocking seal 103 may be provided as an integral part of the frame 12. The frame 12 may be an extruded with the light blocking seal 103 being co-extruded. Or alternatively the seal may be an added piece. When the frame is inserted into a window opening in the wall 105, the frame does not need to be an exact fit to block unwanted light. The seal conforms to irregularities in the opening as it is flexible, and unwanted light is blocked from entering the room from any gaps that might otherwise be present between the wall and shutter frame.

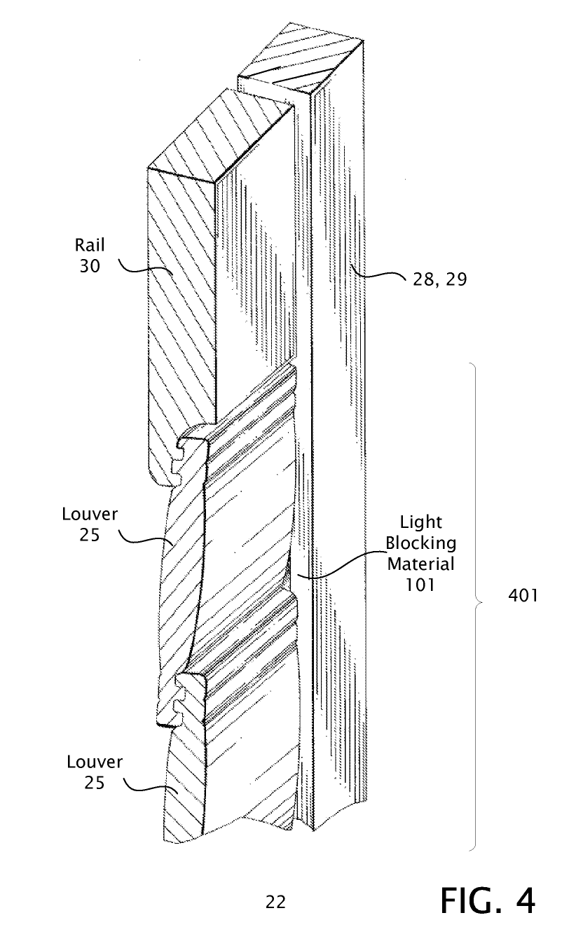

FIG. 4 shows how light may be blocked from entering gaps that may be present between louvers and an aperture in the shutter panel in which the louvers are disposed. Where the louvers 25 are disposed in the shutter panel 22 light may enter between gaps between various surfaces of the louvers that are adjacent to the stiles 28, 29 and rails 30, and/or divider rail (80 of FIG. 1) that for an aperture for the plurality of louvers to be disposed into. On faces of the stiles 28, 29 that abut the louvers a light blocking material 101 may be disposed in a gap formed there between to block unwanted light. Where the louvers 25 are adjacent to a rail 30, or divider rail (80 of FIG. 1) one or more grooves may be provided in the rail 30 to accept a mating ridge in the louver. One or more sets of ridges and grooves may be provided to block unwanted light. Accordingly by utilizing the specially constructed louvers and rails (or divider rails) in conjunction with light blocking material disposed about the perimeter of the aperture in the shutter panel light infiltration may be greatly reduced, or eliminated.

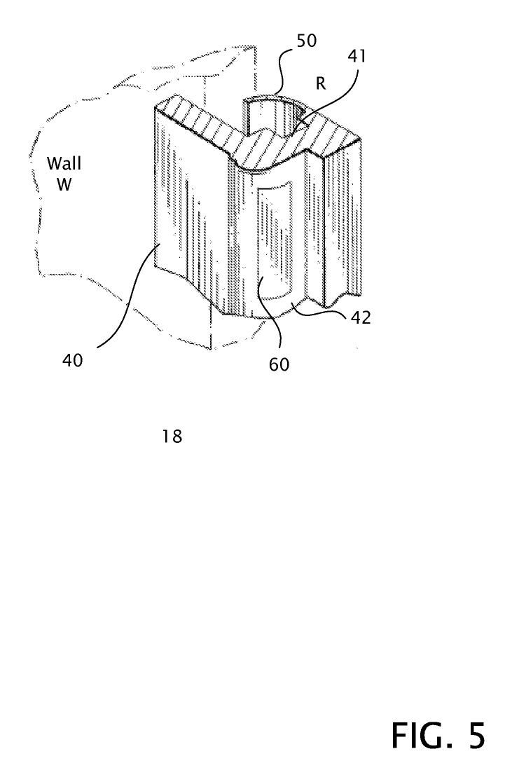

FIG. 5 is a partial perspective view of a representative section of the exterior frame, (18, 20, 16, 14 of FIG. 1), with a section of a representative frame member 18 being shown. Each of the frame members and shutter members is preferably fabricated by extrusion from a suitable synthetic material such as a polymeric material such as polyvinyl chloride, polyethylene, polystyrene, polypropylene being representative.

Each of the frame members are generally L-shaped having a facing 40, and a rearwardly depending leg 42 which is generally perpendicular to the facing 40 and may be relieved at 41 to reduce material requirements. The facing 40 abuts the wall W and the leg 42 is positioned in a recess R such as the space formed around a window. The recess R is often not dimensionally uniform and may be irregular. Shutter frames are often pre-manufactured based on the nominal dimensions of the recess and they may require extensive cutting and fitting at installation. Cutting and trimming requires time on the part of the installer, increasing costs to the consumer.

To provide for efficiency of installation and also to block light that may infiltrate around the frame, the outer frame or sections of the frame 18 are provided with a co-extruded seal 50 which is a flap of flexible material which will engage the recess wall, providing a clearance space to facilitate installation and squaring of the frame within the recess.

In alternative examples a light blocking seal 60 can be provided or attached to the surfaces “S” of the frame 12 along members 14, 16, 18 and 20. The seal 60, may be a flexible flap projecting from the edge of the frame. The seal is fabricated from a flexible polymeric material and co-extruded with a component of the assembly such as the louver panel frame section 18, making the seal an integral component which can be efficiently fabricated in the same process as the shutter components.

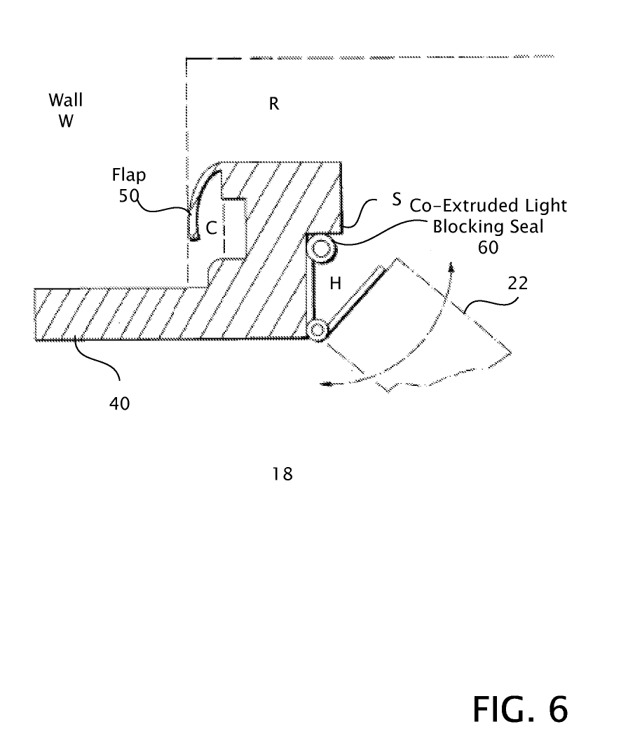

FIG. 6 is a cross-sectional view of a section of an exterior shutter frame as seen in FIG. 5 provided with another embodiment of the co-extruded light-blocking seal 60. Louver panel 22 is shown as hinged at H to the frame section 18 and, when closed, the seal 60 will block infiltration of light from the window recess R around the frame 12. Flap 50 will also assist in blocking light. The co-extruded light-blocking seal 60 is shown as circular and the seal may take other configurations such as oval or semi-spherical.

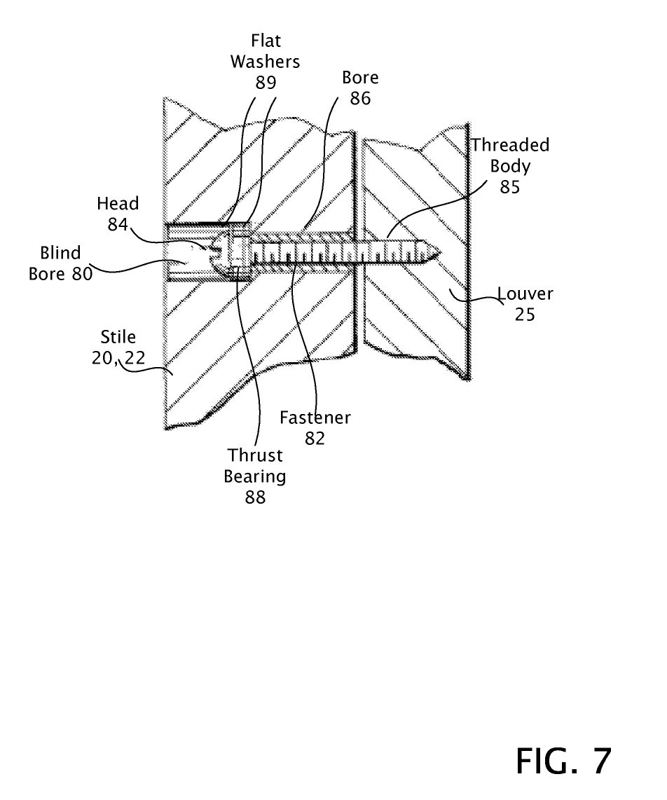

FIG. 7 shows a tight screw assembly for securing and adding structural integrity to a louver panel 22, particularly a louver panel having increased height. Typically a louver panel such as louver panel 22, which exceeds five feet in height, typically requires a divider such as a fixed bar member extending between the vertical stiles (28, 29 of FIG. 1), generally positioned at an intermediate location to align with the window frame. FIG. 1 shows a representative shutter assembly having a divider rail 80. However, such a divider rail 80 can distract from the overall aesthetics of the louver panel. Accordingly, the support provided by the fixed divider rail 80 can be eliminated by incorporating tight louver screw assemblies at selected locations between the stile's and louvers 25 to provide the necessary structural integrity.

Blind bores 80 are provided in the outer edges of opposite stiles 28, 29 adjacent the ends of a louver 25 at a selected location. The blind bores 80 each receives a fastener 82 shown as an elongate, screw having a head 84, such as a flathead, and a threaded body section 85. The screws extend through bores 86 in the opposite stiles and the end of the screws engage the ends of the adjacent louver 25 end. Bearings 88, which are thrust bearings, are interposed between the bottom of the blind bores 81 and the heads 84 of the screws. Low friction flat washers 89 of nylon or other suitable material are interposed on opposite sides of the thrust bearing 88. The screws are then tightened into engagement with the louver 25 so that the screws and louver 25 turn together. The bearings 88 allow the screws to turn with the louver as an integral unit. Thus, the louver screw secured to the stiles and to the louver in this way provides additional structural integrity between the stiles, often eliminating the need for a divider rail and also reduce the tendency of the screws to “strip” out of the louver end.

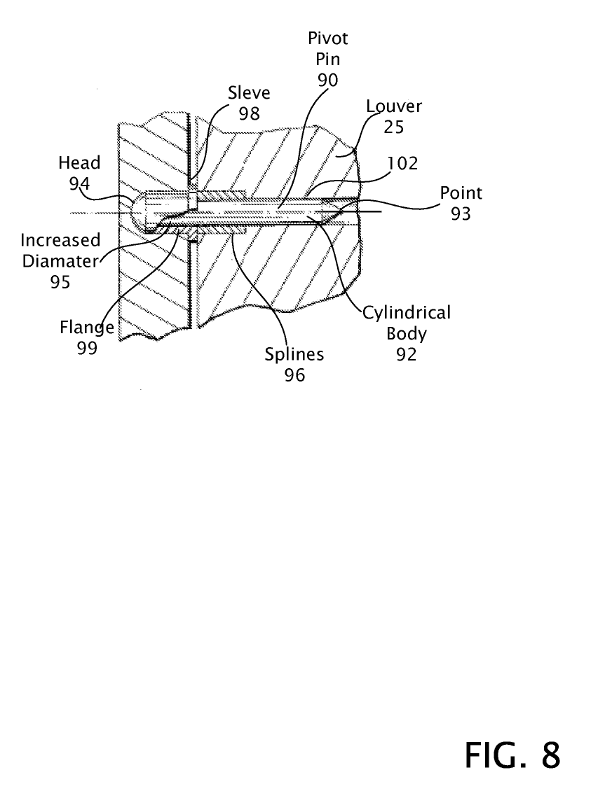

FIG. 8 is a detail view of a shutter stile and an adjacent louver broken away showing the installation of a tension-control pins placed between the stile and louver at selected locations to frictionally secure the louvers to prevent the tilt rod from causing the louvers to pivot. Another problem with conventional shutters is that over a prolonged period of use, wear and tear will occur between the louver pivot pin and stile so the weight of the tilt rod will cause unintended movement of the louver causing the louvers to pivot to a closed position from a selected open or partially open position. With the present structure, this problem is alleviated by the use of pivot pins 90. As seen in FIG. 5, the pivot pins 90 extend between the vertical stiles 28, 29 and the adjacent louver 25 at pivot locations.

The pivot pins 90 have an elongated cylindrical body 92 having a point 93 at one end and a head 94 at the opposite end. The body 92 has a section 95 of increased diameter immediately adjacent the had which is a bearing surface. A portion of the body 92 may be provided with axially extending ribs or splines 96 to increase frictional engagement with the louver 25.

A sleeve 98 extends about the bearing surface of section 95 and is retained by the head 94. The inner end of the sleeve carries a flange 99. The head and the sleeve of the tension pins are inserted in a blind bore in the stiles 28, 29 at selected locations. The flange 98 will abut the vertical, inner edge of the adjacent stile. The body of the pins 90 are inserted into an aligned bore 102 in the end of the louver in a tight fit and further secured by the splines 96. The louver 25 and pin body rotate supported by the fixed bearing sleeve 98, reducing the tendency of the pivot pin from “stripping” out of the louver.

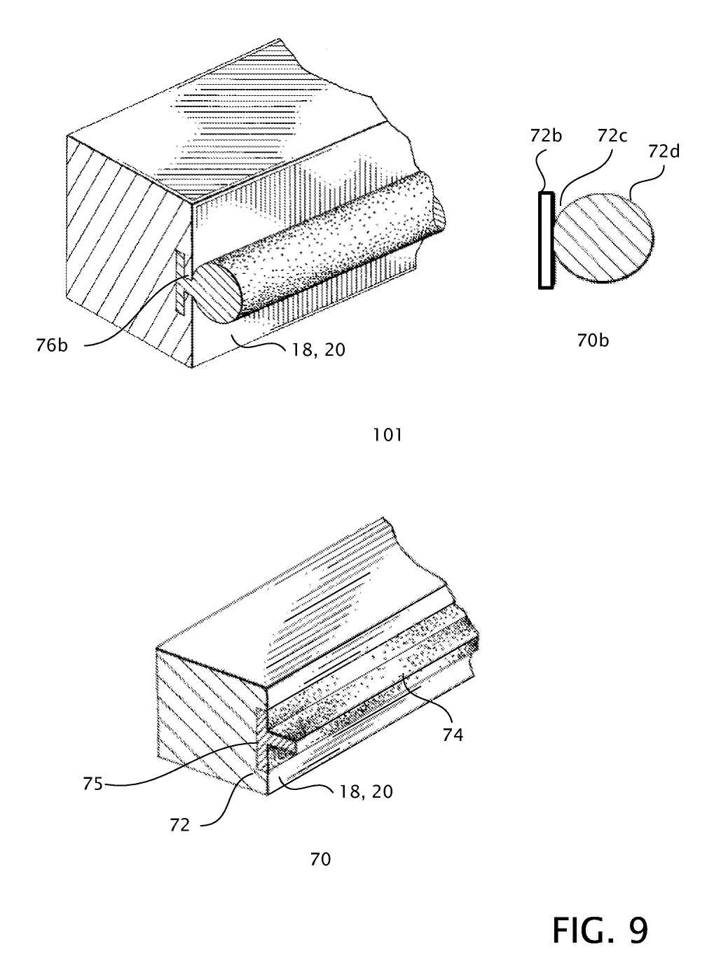

FIG. 9 shows examples of a light-blocking material 101 according to the present invention in which light-blocking seal 101 is disposed along an edge of a shutter component, such as along the inner edges of stiles 18, 20, and rails 14, 16, or to the edges of the frame as previously described herein. The light-blocking material 101 may take several forms in the materials utilized and in its construction.

A light seal 70b is disposed into to the edge of a shutter component such as adjacent to (such as being disposed into a grove 76b) the inner edges of stiles 18, 20, and rails 14, 16, or to the edges of the frame or other component in which light is to be blocked. The light-blocking seal 70b, rather than being co-extruded, is slidably disposed into a channel 76b, and in alternative examples may be or bonded or adhesively secured to hold it in place, to its associated shutter component. As shown, the light-blocking seal is generally made of a siliconized pile material 72d or its equivalent, and is generally curved, or round in shape, with a substantially tangent point on the outer circumference of the pile surface 72c bonded to a flexible strip 72b. Securing the pile 72d to the backing strip 72b in this way provides relief for the protruding ledges of the channel 76b so that the light blocking seal 70b may be easily slid into the channel 76b. The strip 70b is inserted into a typically T-shaped grove or channel 76b disposed into the stile 18 The backing strip 72b may be made of any suitable material that is rigid, flexible and also easily bonded glued or otherwise attached to the pile material 72d. The pile material may be a siliconized pile, a felt or pile material which may be natural fibers such as cotton or wool or synthetic fibers such as polyamide. The pile material 72d is provided in a suitable color such as black or white, depending on the light blocking preference of the user. The seal 70b, for example, will block much of the light infiltration between the stile and, louver edges.

The alternative light-blocking material 70, rather than being co-extruded, is adhesively secured or bonded to its associated shutter component. The light-blocking seal is generally T-shaped having a base 72 and an upwardly projecting leg 74. The base and leg are formed from a suitable material such as a felt or pile material which may be natural, fibers such as cotton or wool or synthetic fibers such as polyamide. The seal 70 is provided in a suitable color such as black or white, depending on the light blocking preference of the user. Preferably the edges of the stiles and, rails to which the seal 70 is attached are slightly undercut or routed at 75 to accommodate insertion and adhesive securement of the base portion 72 of the light-blocking seal. The seal 70, for example, will block much of the light infiltration between the stile and louver edges.

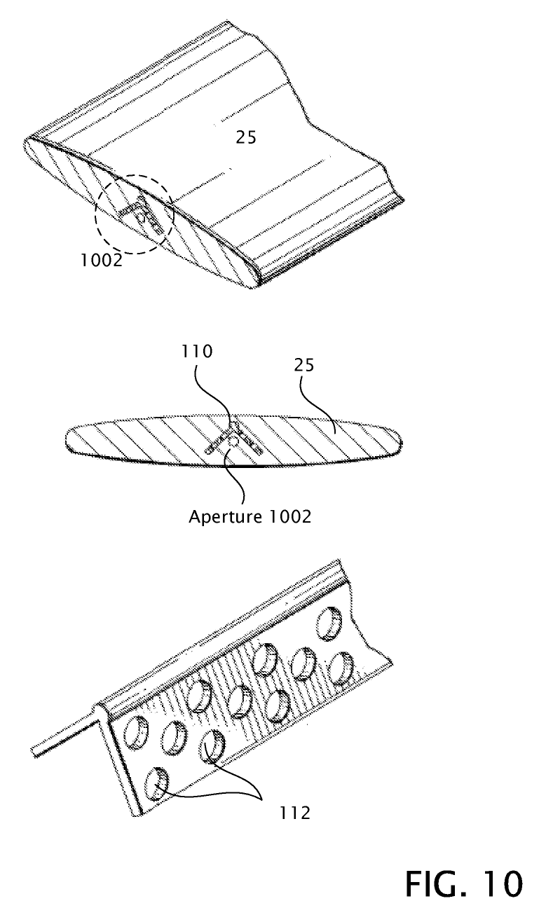

FIG. 10 shows a representative louver component 25 with internal support 1002 which may be manufactured by a co-extrusion process. In shutters having adjustable louvers, the louvers are supported for pivoting on opposite stiles by pivot pins disposed in an aperture 1003. The assembly and fabrication of this type of shutter involves the steps of fabricating the components and completing the frame structure in which the louver panels are to be installed. Shutters made of polymeric materials have a distinct advantages in terms of durability, reduced warpage, ease of fabrication, although even these materials may sag particularly after a long period of installation in windows where the louvers are subject to high temperatures.

As mentioned above, the louvers 25 are preferably fabricated by extrusion from a suitable polymeric material. In order to provide additional strength and resistance to sagging and loss of structural integrity, the extruded louvers are provided with an embedded stiffening section 110. The embedded stiffening section 110 is shown as a generally inverted V-shaped metal section, preferably aluminum, which can be incorporated at the time of extrusion and to provide the desired additional strength. The section is perforated at multiple locations 112 along its length for weight reduction and for increased adhesion within the louver.

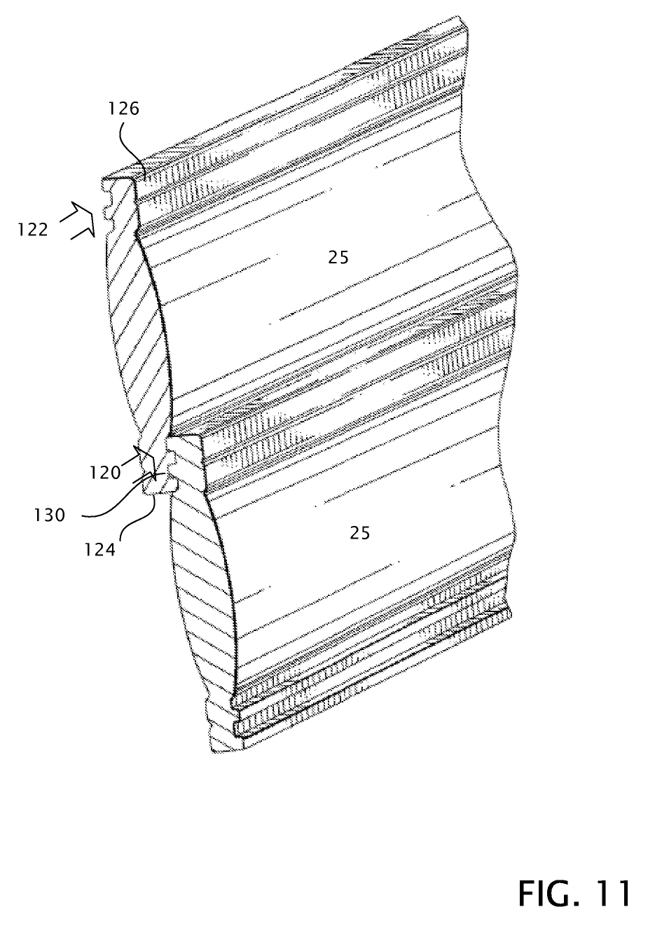

FIG. 11 is a perspective view of louvers 25 having edges provided with grooves 120, 122 which inter-engage with adjacent louvers or shutter rails when the louvers are closed to block light. Another source of light infiltration occurs between adjacent louver edges when the louvers are closed as louvers with out edges simply rest against each other. Louver 25 may be provided with light-blocking features 120, 122 formed along the opposite edges 124, 126 of the louver 25. Any number of groves may be provided to form a meandering channel to block light infiltration. Also as shown each set of grooves and ridges disposed at opposite ends of the louver 124, 124 are disposed on opposite sides of the louver 25 so that when the louvers are closed each lover engages with its neighbor.

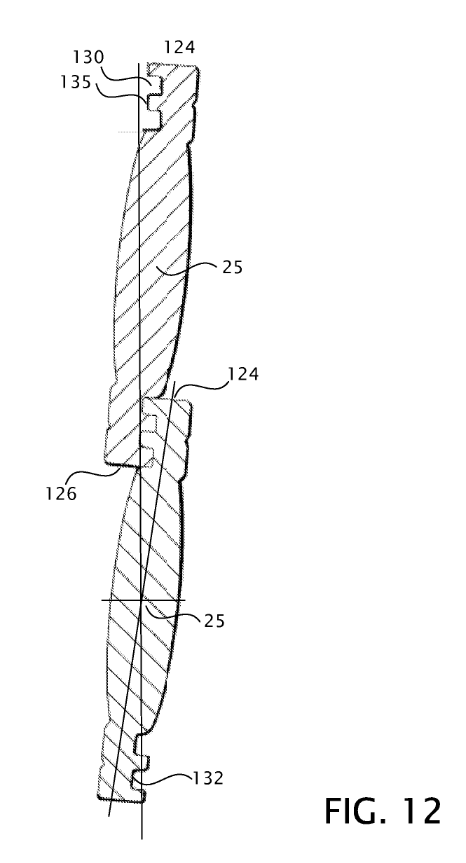

FIG. 12 shows a pair of louvers 25 in a closed, light-blocking position from the end. The light-blocking features each comprise a pair of parallel spaced-apart grooves 130 forwardly facing along one edge 124 of the louver, separated by a projection 135. The terms “forwardly facing” denote an orientation toward the room when the louvers are closed. The opposite louver edge 126 is also provided with a pair of parallel grooves 132. The grooves 130, 132 are sized and positioned so that the grooves 130 along the edge 124 of a louver inter-engage with the grooves 132 along the edge 126 of the next adjacent louver when the louvers are closed as shown here.

The upper louver rail and the lower louver rail are provided with compatible configurations to engage the upper edge of the upper most louver and the bottom edge of the lower most louver in the louver panel.

Although, for most efficient light-blocking, the louver edges with multiple grooves, may work well, since grooves in the shutter louver edges are an efficient light-blocking configuration, other inter-engaging configurations may also be utilized. A single groove along each louver edge may be sufficient for some installations.

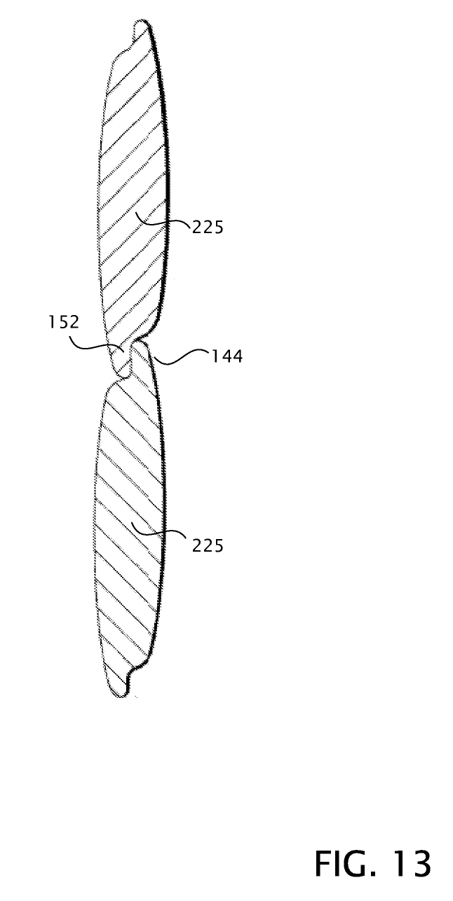

FIG. 13 is a cross-sectional view showing two alternatively constructed louvers 225 each, closed in a light-blocking position. The edges 142, 144 of the adjacent louvers 225 are routed forming opposite facing shoulders 150, 152 which inter-engage and abut when the louvers are closed to provide light-blocking. The louvers are symmetrical in construction so that when assembled the tab 152 of one louver, fits into a recess 144 of the adjacent louver.

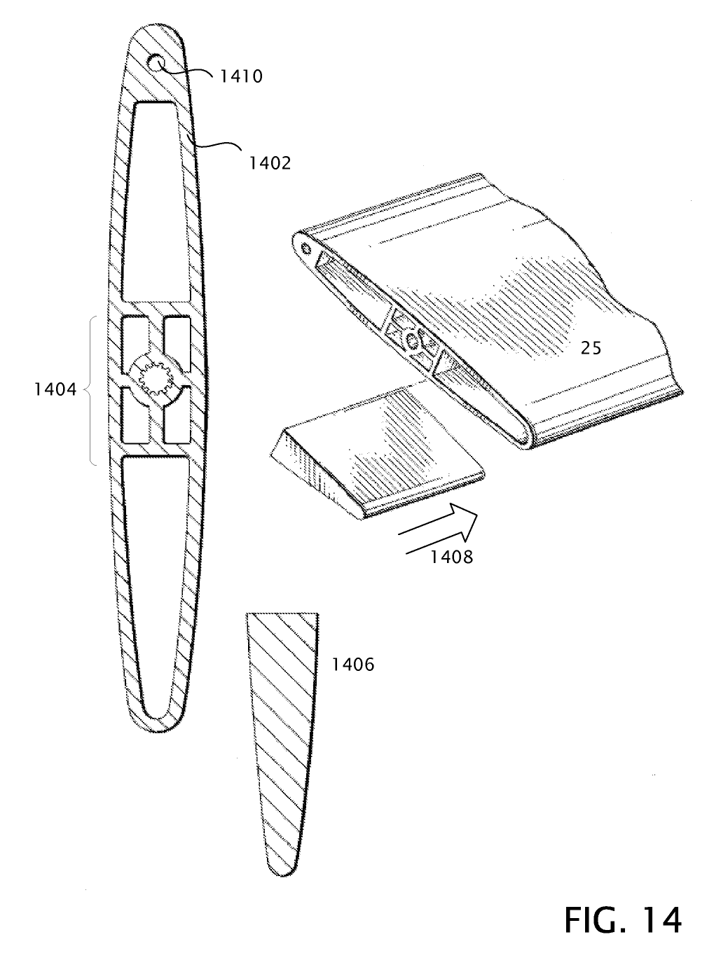

FIG. 14 shows a further alternative example of louver construction that may increase louver rigidity, while saving materials the louver 25 shown may be formed from any convenient material. As seen from the end 1402 the structure has cavities to save materials and reduce weight. At the center 1404 where extra rigidity may be of use extra support provided by internal members or braces formed into the material is provided. Also show is an insert 1406 that may be added if it is determined that additional strength is needed, by sliding it 1408 into a corresponding cavity. In the louver shown provision for an end mounted tilt rod is provided by an aperture 1410 disposed at an edge of the louver 25.

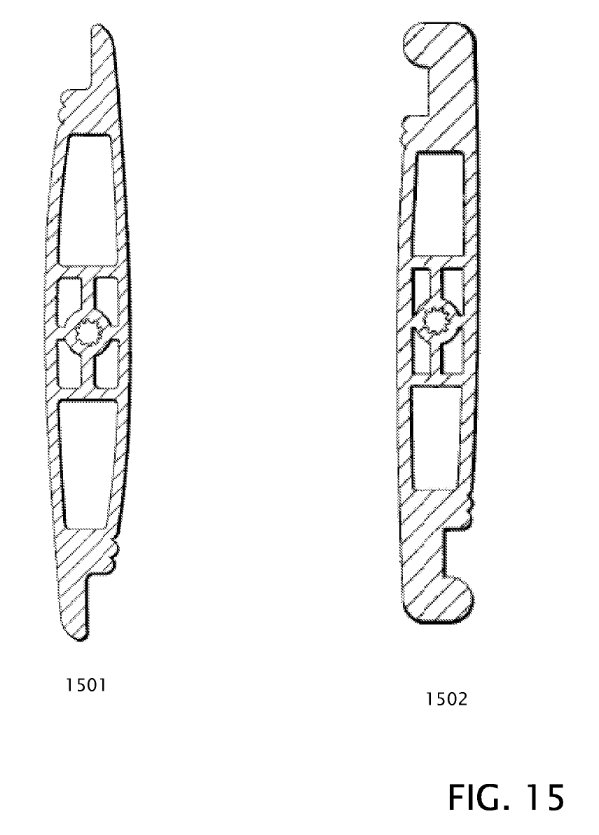

FIG. 15 shows yet further alternative examples of louver construction. As can be seen in the figure alternative louver configurations 1501, 1502 are possible that incorporate many of the features described herein.

It will be obvious to those skilled in the art to make various changes, alterations and modifications to the invention described herein. To the extent such changes, alterations and modifications do not depart from the spirit and scope of the appended claims, they are intended to be encompassed therein.

Those skilled in the art will realize that the process sequences described above may be equivalently performed in any order to achieve a desired result. Also, sub-processes may typically be omitted as desired without taking away from the overall functionality of the processes described above.

1. A light blocking shutter comprising:
a frame having a first light blocking material for preventing light from entering a room from a space between the frame and a wall in which the frame is mounted;
a shutter panel coupled to the frame and including a second light blocking material disposed between a gap formed between the frame and the shutter panel.

2. The light blocking shutter of claim 1 further comprising:
an aperture formed in the shutter panel having a third light blocking material disposed about a perimeter of the aperture; and
a plurality of louvers disposed within the aperture such that the light blocking material further prevents light from entering the room.

3. The light blocking shutter of claim 2 in which each louver of the plurality of louvers includes a plurality of interlocking ridges that function to prevent light from entering the room through horizontal gaps between the louvers.

4. The light blocking shutter of claim 1 in which the first light blocking material is co-extruded with the frame

5. The light blocking shutter of claim 1 in which the second light blocking material is a pile material coupled to a backing strip.

6. The light blocking shutter of claim 5 in which the second light blocking material is disposed in a “T” shaped grove.

7. The light blocking shutter of claim 3 in which the plurality of ridges of a first louver and a last louver couple to a matching set of ridges in a first rail and a second rail of the shutter panel respectively.

8. The light blocking shutter of claim 1 in which the second light blocking material is disposed about the perimeter of the shutter panel.

9. The light blocking shutter in which the third light blocking material is disposed in a plurality of stiles and a plurality of rails of the shutter panel.

10. A light blocking shutter comprising:
a frame formed from polymeric materials having a first light blocking material to block light from entering a gap between the frame and a wall;
a shutter panel having a top rail and a bottom rail and a first stile and a second stile, and coupled to the frame by a plurality of hinges and a light blocking material disposed about an external perimeter of the shutter panel; and
a plurality of interlocking louvers disposed in an aperture in the shutter panel in which the first stile and the second stile include a third light blocking material abutting an end of each louver of the plurality of louvers.
